(19) United States
(12) Patent Application Publication
(10) Pub. No.: US 2021/0329887 A1
(43) Pub. Date: Oct. 28, 2021

(54) BALLASTED PET FURNITURE

(71) Applicant: SportPet Designs, Inc., Waukesha, WI (US)

(72) Inventors: Adam Kellogg, Oconomowoc, WI (US); Miles Harvey, Brookfield, WI (US)

(21) Appl. No.: 16/857,826

(22) Filed: Apr. 24, 2020

(51) Int. Cl. A01K 15/02; F16B 9/02

(52) U.S. Cl. CPC A01K 15/024; F16B 9/02

(57) ABSTRACT

A furniture item for a house pet includes a base configured to support the furniture item on a horizontal support surface, and an upright portion coupled to the base. The upright portion extends to a height above an upper surface of the base when the base is situated on the horizontal support surface. The upright portion includes a hollow inner portion defining a ballast cavity and an opening providing access to the ballast cavity. The upright portion further includes a cap portion engageable with the hollow inner portion to close the opening, and a removable scratch pad supported on an outside surface of the hollow inner portion. The cap portion has a shield portion that encloses an upper edge of the removable scratch pad when the cap portion is engaged with the hollow inner portion to close the opening.

### BACKGROUND

The invention relates to pet furniture, including for example scratching posts for house cats.

### SUMMARY

In one aspect, the invention provides a furniture item for a house pet. The furniture item includes a base configured to support the furniture item on a horizontal support surface, and an upright portion coupled to the base. The upright portion extends to a height above an upper surface of the base when the base is situated on the horizontal support surface. The upright portion includes a hollow inner portion defining a ballast cavity and an opening providing access to the ballast cavity. The upright portion further includes a cap portion engageable with the hollow inner portion to close the opening, and a removable scratch pad supported on an outside surface of the hollow inner portion. The cap portion has a shield portion that encloses an upper edge of the removable scratch pad when the cap portion is engaged with the hollow inner portion to close the opening.

In another aspect, the invention provides a furniture item for a house pet. The furniture item includes a base configured to support the furniture item on a horizontal support surface. A mount is secured to the base. An upright portion is coupled to the base via the mount. The upright portion extends to a height above an upper surface of the base when the base is situated on the horizontal support surface. The upright portion includes a hollow inner portion defining a ballast cavity and an opening providing access to the ballast cavity, a cap portion engageable with the hollow inner portion to close the opening, and a removable scratch pad supported on an outside surface of the hollow inner portion. The mount is provided as a quick-disconnect mount providing selective mounting and dismounting of a bottom end of the upright portion without the use of tools.

In yet another aspect, the invention provides a furniture item for a house pet. The furniture item includes a base configured to support the furniture item on a horizontal support surface. A mount is secured to the base, and a post is coupled to the base via the mount. The post includes a hollow inner portion defining a ballast cavity and an opening providing access to the ballast cavity, a cap portion engageable with the hollow inner portion to close the opening, and a removable scratch pad sleeve fitted to an outside surface of the hollow inner portion. The mount is provided as a quick-disconnect mount providing selective mounting and dismounting of a bottom end of the post without the use of tools. The cap portion covers an upper edge of the removable scratch pad when the cap portion is engaged with the hollow inner portion to close the opening.

Other aspects of the invention will become apparent by consideration of the detailed description and accompanying drawings.

### BRIEF DESCRIPTION OF THE DRAWINGS

FIG. 1 is a perspective view of a piece of pet furniture, including a base and an upright portion, according to one embodiment of the disclosure.

FIG. 2 is an exploded assembly view of a portion of the pet furniture of FIG. 1.

FIG. 3 is a cross-sectional view of the pet furniture, taken along line 3-3 of FIG. 1.

FIG. 4 is a bottom perspective view of a hollow inner portion of the upright portion.

FIG. 5 is a top perspective view of a receiving portion of the base that receives the bottom end of the upright portion.

FIG. 6 is a bottom perspective view of the base.

FIG. 7 is a cross-sectional view of the base, taken along line 7-7 of FIG. 6 to illustrate the fastener connection between a bottom panel of the base and the receiving portion.

FIG. 8 is a perspective view of a piece of pet furniture according to another embodiment of the disclosure.

### DETAILED DESCRIPTION

Before any embodiments of the present invention are explained in detail, it is to be understood that the invention is not limited in its application to the details of construction and the arrangement of components set forth in the following description or illustrated in the following drawings. The invention is capable of other embodiments and of being practiced or of being carried out in various ways.

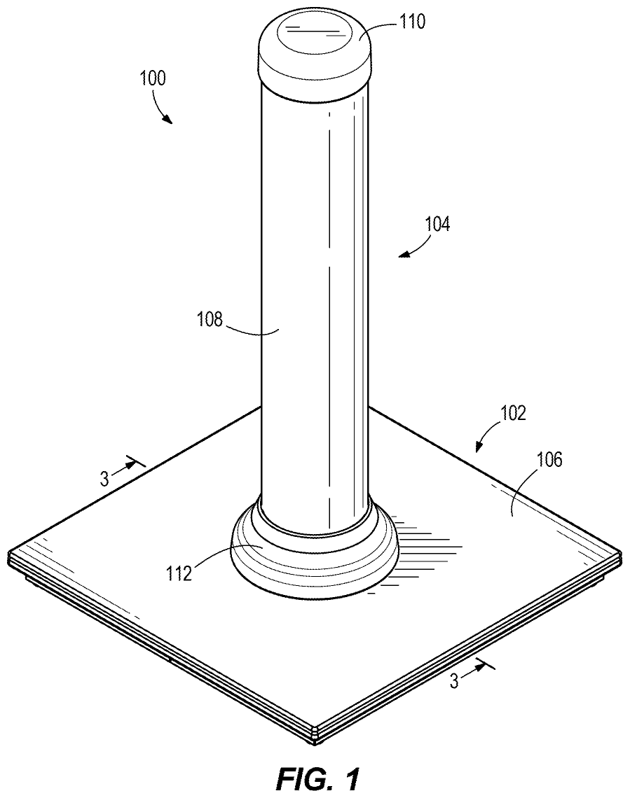

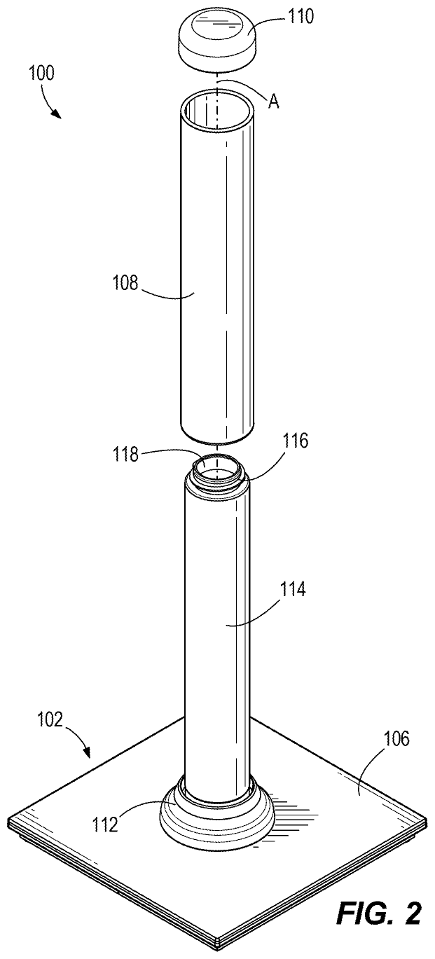

FIGS. 1-2 illustrate a piece of pet furniture 100, also referred to herein as a pet furniture item. The pet furniture item 100 includes a base 102 configured to support the furniture item 100 on a horizontal support surface, e.g., a floor within a home or an outdoor ground surface. The base 102 can include an upper surface 106 and an opposite lower surface configured to be placed on the support surface. The base 102 can be formed of a single piece or assembled from a plurality of pieces. The illustrated base 102 is rectangular (and more particularly the base 102 is square) in plan view, but the base 102 may be provided in other shapes. An upright portion 104 is coupled to the base 102 and extends upward above the upper surface 106 of the base 102. As illustrated, the base 102 and particularly the upper surface 106 thereof is planar, and the upright portion 104 extends along an axis A (FIG. 2) orthogonal to the base plane. The pet furniture item 100 is particularly configured as a scratching post for a domestic house pet, for example a cat. As such, a scratch pad 108 is provided on the upright portion 104. Despite the specific constructional details mentioned and illustrated herein, the pet furniture item 100 can be alternately configured in other constructions. For example, the upright portion 104 may extend non-orthogonally (i.e., skew) from the base 102. In these or other constructions, the scratch pad 108 may have one or more flat sides providing a scratch surface(s). In some constructions, the upright portion 104 may only be partially covered by the scratch pad 108, or have no scratch pad at all. As illustrated, the scratch pad 108 covers and is exposed around an entire periphery of the upright portion 104 (e.g., a full 360 degrees about the axis A). Furthermore, the scratch pad 108 can form a majority of the axial length of the upright portion 104 (e.g., 90 percent or more) as it serves to form the primary functional or pet-engaging portion thereof. However, as will be discussed in further detail below, the upright portion 104 incorporates additional features that improve performance and ease of use. A mount 112 for the upright portion 104 is provided at the interface between the base 102 and the upright portion 104.

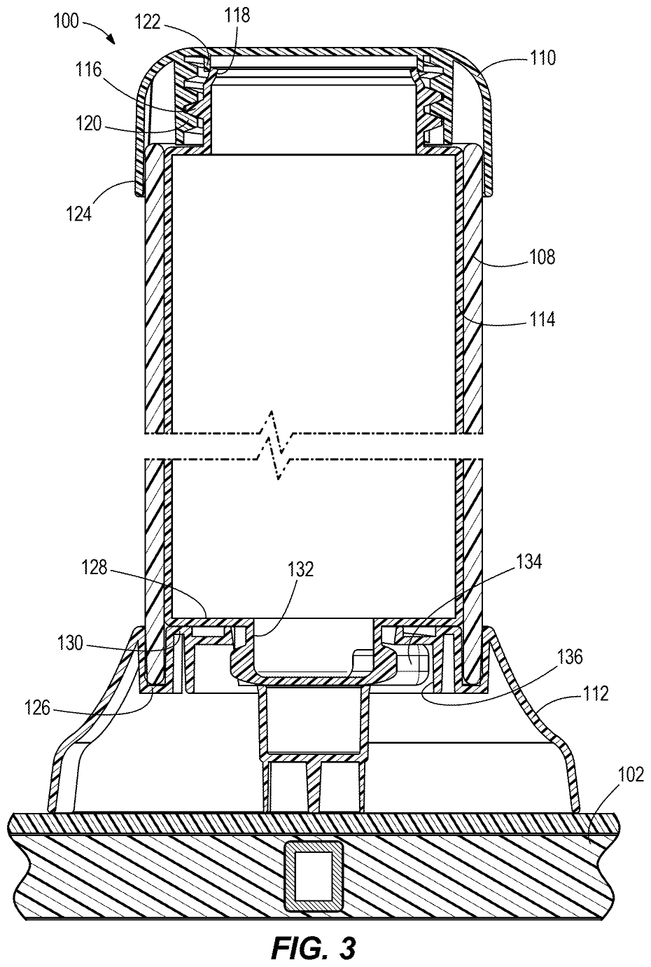

As shown in FIGS. 2 and 3, the upright portion 104 includes a hollow inner portion 114, an outside surface of which supports the scratch pad 108. The hollow inner portion 114 defines a ballast cavity and an opening 118 providing access to the ballast cavity. The opening 118 is provided at the distal or top end of the hollow inner portion 114 as shown. The ballast cavity can receive a quantity of ballast, e.g., in the form of water, sand, cat litter, etc. in order to ballast or weigh-down the pet furniture item 100. The interior volume of the hollow inner portion 114 can be 0.5 liter or more in some constructions, e.g., up to 3 liters. The interior volume, like the hollow inner portion 114 as a whole, can be shaped as a cylinder, among other shapes. Slight variations in the shape occur at the upper and/or lower ends such that the shape is not perfectly cylindrical for an entirety of the axial length. At the distal end of the hollow inner portion 114, a cap portion 110 is provided. The cap portion 110 is engageable with the hollow inner portion 114 to close the opening 118.

In order to provide good sealing so that the ballast material is retained inside the cavity, the cap portion 110 includes an inward projection 122 that protrudes from an end wall of the cap portion 110 to contact the opening 118 when the cap portion 110 is fully seated or engaged. As illustrated, the hollow inner portion 114 and the cap portion 110 are engaged by respective screw threads 116, 120. In the illustrated construction, the screw threads 120 of the cap portion 110 form a female threaded portion that receives the screw threads 116 forming a male threaded portion of the hollow inner portion 114. The cap portion 110 further has a skirt or shield portion 124 that extends down from the end wall to enclose an upper edge of the scratch pad 108 when the cap portion 110 is engaged with the hollow inner portion 114 to close the opening 118. Axial overlap between the shield portion 124 and the scratch pad 108 can be kept small, e.g., 3 cm or less in some constructions, so that the edging is protected without blocking a substantial usable area. In some constructions, the scratch pad 108 is a removable scratch pad that can be simply replaced without causing disposal of the entire pet furniture item 100 should the material of the scratch pad 108 be deemed worn-out or no longer suitable for the pet by the pet owner. For example, the scratch pad 108 can be provided as a sleeve that slides over the outside surface of the hollow inner portion 114. The cap portion 110 may be the sole retention means for maintaining the scratch pad 108 on the hollow inner portion 114 so that the scratch pad 108 can be simply replaced once the cap portion 110 is disengaged. In other words, the scratch pad 108 is not bonded onto the hollow inner portion 114, nor fastened thereto (e.g., sewn, stapled, nailed, screwed, or attached with hook-and-loop tape such as Velcro®). As such, the scratch pad 108 can be removed by sliding off the hollow inner portion 114 immediately following removal of the cap portion 110. In other constructions, the scratch pad 108 may be retained on the hollow inner portion 114 by an additional means in conjunction with the cap portion 110 or in lieu of the cap portion 110. The scratch pad 108, at least the useful outer surface thereof, can be constructed of fibrous material such as carpet or sisal. Furthermore, the pet furniture item 100 can be provided with a system of interchangeable scratch pad refills of different types to suit different pet needs. The upper surface 106 of the base 102 may also optionally be covered in a similar fibrous material to either match with or contrast that of the upright scratch pad 108.

FIG. 3 illustrates the pet furniture item 100 in cross-section taken through the axis A as shown in FIG. 1. A central portion of the height of the pet furniture item 100 is omitted, the omitted portion having a uniform cross-section. Although not apparent from the truncated cross-section, the upright portion 104 can have a length-to-width ratio of at least 3:1, 4:1, or 5:1 (but not exceeding 10:1, for example). As shown in FIG. 3, the mount 112 can be provided with a channel 126 that receives a bottom edge of the scratch pad 108. Similar to the way that the cap portion 110 conceals the scratch pad upper edge, the mount 112 conceals the scratch pad lower edge. The channel 126 can be form-fitting to the material thickness of the scratch pad 108, but need not be in other constructions. As shown, the axial position of the scratch pad 108 cannot be set in direct relation to the hollow inner portion 114 due to the sliding relationship, and the scratch pad 108 is instead supported by the channel 126, particularly a bottom wall or shelf thereof. A bottom end wall 128 of the hollow inner portion 114 is supported by another wall or shelf 130 of the mount 112 positioned radially inward of the channel 126. The end wall 128 can extend perpendicular to the axis A and can form a shoulder surrounding a central mounting feature, in the illustrated example an axial projection 132 from which extend a pair of diametrically-opposed wings 134, each of which is spaced axially below the end wall 128. Although the two wings 134 extend radially opposite one another, the hollow inner portion 114 can be provided with alternate configurations of wings on the axial projection 132.

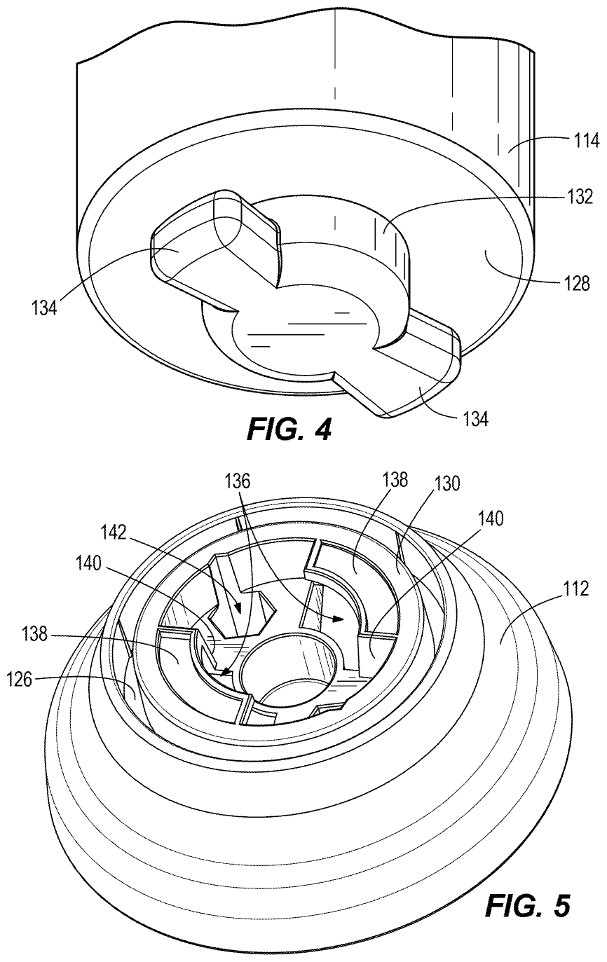

The mounting interface between the mount 112 and the bottom of the hollow inner portion 114 is discussed in further detail with reference to FIGS. 4 and 5. In particular, FIG. 5 illustrates that the mount 112 includes a receptacle 136 for each of the wings 134. Each receptacle 136 is configured to receive all or a portion of the corresponding wing 134 such that the wing 134 can be rotated into the receptacle 136 under a retainer wall 138 after joining the hollow inner portion 114 and the mount 112 toward each other by a first axial movement to bring the wings 134 into axial register with the receptacles 136. A receptacle end wall 140 is provided to limit the assembly-direction rotation of the hollow inner portion with respect to the mount 112 and define a fully-engaged position therebetween. With the wings 124 received in the receptacles 136, the retainer walls 138 reside axially between the wings 124 and the bottom end wall 128. As described, the hollow inner portion 114 and the mount 112 provide a tool-less bayonet mount that allows simple assembly and disassembly by hand as the wings 124 follow an L-shaped path into the fully-engaged position. Other configurations of bayonet mounting may be provided between the mount 112 and the hollow inner portion 114, for example reversing the positions of the wings 134 and receptacles 136 and/or rearranging the wings 134 (with corresponding rearrangement of the receptacles 136). In yet other constructions, another type of quick-disconnect fitting may be provided between the mount 112 and the hollow inner portion 114 (e.g., a press-in snap fit).

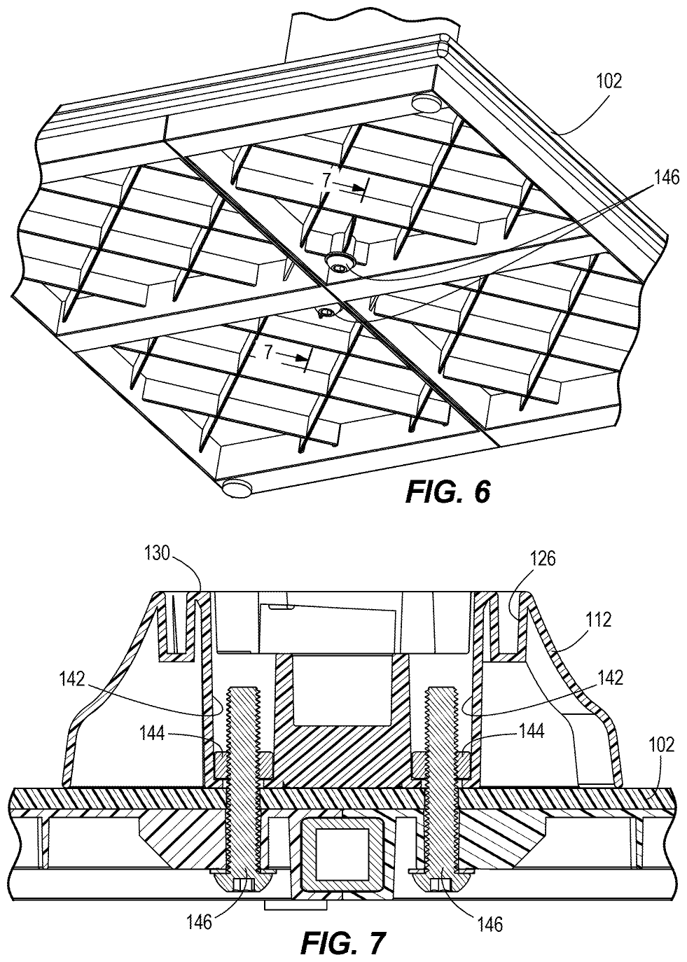

Although the mount 112 can be coupled to the base 102 in any number of alternate ways, or provided integrally therewith, the illustrated manner of attachment is shown in at least FIGS. 5-7. As shown in FIG. 5, additional receptacles 142 are provided in the mount 112 as fastener receptacles. The fastener receptacles 142 are open to the upper side of the mount 112 and have a hex profile shape for retaining a nut 144 in a prescribed rotational position. A screw 146 is assembled from underneath the mount 112 to pass through an aperture in a bottom wall of each fastener receptacle 142. The screw 146 engages the nut 144, clamping the nut 144 against the bottom wall and compressing the mount 112 down to the base 102. The illustrated arrangement can be reversed such that the screws 146 assemble from the top side of the mount 112, while the fastener receptacles 142 and the nuts 144 are provided on the bottom side. Alternate arrangements for removable or permanent coupling between the base 102 and the mount 112 are optional, including but not limited to rivets, heat staking, etc.

The pet furniture item 100 can be manufactured and sold unballasted. The end user can put the pet furniture item 100 to use with or without ballast. If the user desires to ballast the pet furniture item 100, the user removes the cap portion 110 and pours the ballast material into the cavity inside the hollow inner portion 114. The user can fill the cavity partially or completely before reattaching the cap portion 110. If the user desires to fill the ballast cavity remotely rather than bringing the ballast material to the pet furniture item, the upright portion 104 can be decoupled from the base 102 and carried to a source of ballast material (e.g., a kitchen sink, utility room, etc.). When ballasted, the pet furniture item may increase in overall weight substantially (e.g., 30 percent, 50 percent, or more). The ballast renders the pet furniture item 100 more immovable during hard use by the pet. The pet furniture item 100 is thus more resistant to sliding or tipping and provides a better user experience. And this advantage is achieved without resorting to heavier materials or permanent ballast that encumber the manufacturing, shipping, and purchase experience. The use of ballast material(s) is thus easily reversible as well. If and when the pet owner decides to change the scratch pad 108, this can be accomplished by removal of the cap portion 110, sliding off the old scratch pad, sliding on the new scratch pad, and then replacing the cap portion 110.

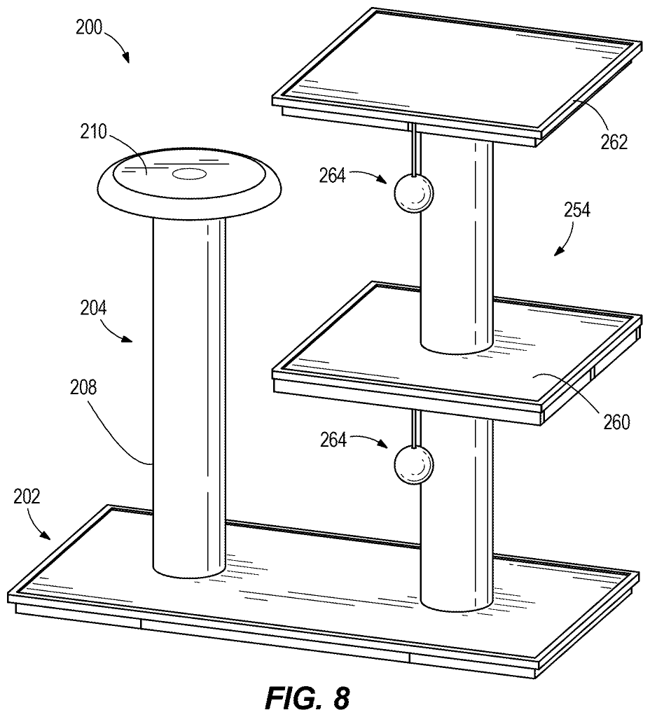

FIG. 8 illustrates a piece of pet furniture 200 according to a second embodiment. The furniture item 200 includes a base 202 and a first upright portion or post 204. A cap portion 210 is provided atop the first upright portion 204. Features of the mount 112 can be incorporated directly into the base 202 so that a separate mount is not provided atop the base 202. Alternately, the first upright portion 204 can be fixed to the base without a quick-disconnect mount (e.g., co-molded together or fastened with screws). The cap portion 210 is shown to extend radially beyond the scratch pad 208, providing an overhang. The diameter of the cap portion 210 can be at least 1.2 times the scratch pad diameter, at least 1.5 times the scratch pad diameter, or at least 2 times the scratch pad diameter. In some constructions, the diameter of the cap portion 210 may not exceed 6 times the scratch pad diameter. Notwithstanding the distinctions mentioned herein, the first upright portion 204 is generally similar to the upright portion 104 of FIGS. 1-7. Thus, although not illustrated, inside the scratch pad 208 lies a hollow inner portion defining a ballast cavity, an opening of which is selectively closed by the cap portion 210, which also covers the upper edge of the scratch pad 208 when engaged.

Additionally, the pet furniture item 200 includes a second upright portion 254 extending up from the base 202 at a position spaced from the first upright portion 204. Although some pet furniture items can be manufactured with two similar upright portions, the illustrated first and second upright portions 204, 254 are dissimilar in construction. For example, the second upright portion 254 includes multiple vertical sections (e.g., post sections) rather than a consistent shape all the way up. The vertical sections (e.g., two separate scratch pad sections or sleeves) are divided by a first horizontal platform 260, which acts as a secondary base spaced above the base 202. Atop the second upright portion 254, a second horizontal platform 262 is provided. The second platform 262 is similar to the first platform 260 and spaced vertically above the first platform 260. One or both platforms 260, 262 can support a hanging toy 264 as shown. The platforms 260, 262, and in some constructions also the cap portion 210 on the first upright portion 204, can provide perching locations for the pet to play or lounge. The second upright portion 254 can be provided with one or more hollow inner portions defining a ballast cavity(ies). The hollow inner portion can span the height of the second upright portion 254 or may be provided only in a lower portion thereof, e.g., between the base 202 and the first elevated platform 260. The platform 260 (or second platform 262) can have an integrated cap portion for closing the opening of the hollow inner portion.

What is claimed is:

1. A furniture item for a house pet, the furniture item comprising:
a base configured to support the furniture item on a horizontal support surface; and
an upright portion coupled to the base and extending to a height above an upper surface of the base when the base is situated on the horizontal support surface;
wherein the upright portion comprises
a hollow inner portion defining a ballast cavity and an opening providing access to the ballast cavity,
a cap portion engageable with the hollow inner portion to close the opening, and
a removable scratch pad supported on an outside surface of the hollow inner portion,
wherein the cap portion covers an upper edge of the removable scratch pad when the cap portion is engaged with the hollow inner portion to close the opening.

2. The furniture item of claim 1, wherein the upright portion is in the form of a post, and the removable scratch pad is in the form of a sleeve fitted to the post.

3. The furniture item of claim 2, wherein both the post and the sleeve have circular shapes in cross-section taken perpendicular to the height, and wherein the cap portion has screw threads for engaging screw threads of the hollow inner portion.

4. The furniture item of claim 3, wherein the screw threads of the cap portion form a female threaded portion that receives a male threaded portion provided by the screw threads of the hollow inner portion.

5. The furniture item of claim 1, wherein the removable scratch pad is retained on the outside surface of the hollow inner portion solely by the cap portion.

6. The furniture item of claim 1, wherein the upright portion is positioned in the center of the base and extends orthogonal to a plane defined by an upper surface of the base.

7. The furniture item of claim 1, further comprising a mount secured to the base, the mount provided as a quick-disconnect bayonet mount into which a complementary projection at the bottom end of the upright portion is configured to be received.

8. The furniture item of claim 1, further comprising a second upright portion coupled to the base and extending above the upper surface of the base, the second upright portion including a second hollow inner portion defining a second ballast cavity.

9. A furniture item for a house pet, the furniture item comprising:
a base configured to support the furniture item on a horizontal support surface;
a mount secured to the base; and
an upright portion coupled to the base via the mount, the upright portion extending to a height above an upper surface of the base when the base is situated on the horizontal support surface,
wherein the upright portion comprises
a hollow inner portion defining a ballast cavity and an opening providing access to the ballast cavity,
a cap portion engageable with the hollow inner portion to close the opening, and
a removable scratch pad supported on an outside surface of the hollow inner portion,
wherein the mount is provided as a quick-disconnect mount providing selective mounting and dismounting of a bottom end of the upright portion without the use of tools.

10. The furniture item of claim 9, wherein the upright portion is in the form of a post, and the removable scratch pad is in the form of a sleeve fitted to the post.

11. The furniture item of claim 10, wherein both the post and the sleeve have circular shapes in cross-section taken perpendicular to the height, and wherein the cap portion has screw threads for engaging screw threads of the hollow inner portion.

12. The furniture item of claim 11, wherein the screw threads of the cap portion form a female threaded portion that receives a male threaded portion provided by the screw threads of the hollow inner portion.

13. The furniture item of claim 9, wherein the removable scratch pad is retained on the outside surface of the hollow inner portion solely by the cap portion.

14. The furniture item of claim 9, wherein the upright portion is positioned in the center of the base and extends orthogonal to a plane defined by an upper surface of the base.

15. The furniture item of claim 9, wherein the cap portion covers an upper edge of the removable scratch pad when the cap portion is engaged with the hollow inner portion to close the opening.

16. The furniture item of claim 9, further comprising a second upright portion coupled to the base and extending above the upper surface of the base, the second upright portion including a second hollow inner portion defining a second ballast cavity.

17. A furniture item for a house pet, the furniture item comprising:
a base configured to support the furniture item on a horizontal support surface;
a mount secured to the base; and
a post coupled to the base via the mount,
wherein the post comprises
a hollow inner portion defining a ballast cavity and an opening providing access to the ballast cavity,
a cap portion engageable with the hollow inner portion to close the opening, and
a removable scratch pad sleeve fitted to an outside surface of the hollow inner portion,
wherein the mount is provided as a quick-disconnect mount providing selective mounting and dismounting of a bottom end of the post without the use of tools, and
wherein the cap portion covers an upper edge of the removable scratch pad when the cap portion is engaged with the hollow inner portion to close the opening.

18. The furniture item of claim 17, wherein both the post and the sleeve have circular shapes in cross-section taken perpendicular to the height, and wherein the cap portion has screw threads for engaging screw threads of the hollow inner portion.

19. The furniture item of claim 17, wherein the removable scratch pad is retained on the outside surface of the hollow inner portion solely by the cap portion.

20. The furniture item of claim 17, wherein the post is positioned in the center of the base and extends orthogonal to a plane defined by an upper surface of the base.
